(19) United States
(12) Patent Application Publication
(10) Pub. No.: US 2021/0156149 A1
(43) Pub. Date: May 27, 2021

(54) ROOF TILE WITH AN IMPROVED COMPOSITION AND METHOD OF MAKING THE SAME

(71) Applicant: Philip Mason, Arlington, TX (US)

(72) Inventor: Philip Mason, Arlington, TX (US)

(21) Appl. No.: 16/698,591

(22) Filed: Nov. 27, 2019

(51) Int. Cl. E04D 1/16; C04B 20/00; C04B 14/20; C04B 14/46

(52) U.S. Cl. CPC E04D 1/16; C04B 20/006; C04B 2111/00594; C04B 14/4668; C04B 14/4675; C04B 14/202

(57) ABSTRACT

A composition for a cementitious roofing tile, the composition includes a cement binder making up 10% to 20% of a total composition weight; a fine aggregate sand making up 20% to 25% of the total composition weight; an aggregate making up 12% to 20% of the total composition weight; a crushed glass making up 15% to 60% of the total composition weight; an alkali-silica reaction (ASR) suppressant; and a predetermined volume of water; the aggregate is selected from one of perlite, vermiculite, hemp, expanded clay, coco coir, shale and slate; and the fine aggregate sand has an average particle size from a minimum of 1 micron to a maximum size of 2 mm; and the crushed glass has an average particle size that ranges from 1 micron to a maximum of 5 mm.

### BACKGROUND

### 1. Field of the Invention

The present invention relates to a roof tile with a unique composition and a method for making the roofing tiles using post-consumer glass and other aggregates, and cement to bind the mix and a hydraulic press to form the tile.

### 2. Description of Related Art

The traditional method of building a Bermuda “slate” roof for the last 400 years has been to use quarried natural limestone tiles that measure 18″×12″×1″ (45.7 cm×30.4 cm×2.5 cm) thick (Traditional Tile). These Traditional Tiles are overlapped and bedded in mortar and rest on top of permanent timber roof framing. The roof is considered a ballast type construction relying primarily on the dead weight of the stone and mortar to keep from lifting off in high winds (e.g. hurricanes). However, in recent years major hurricanes (Category 3 and above) have become more frequent and severe with several storms causing extensive roof damage island wide. Hurricane damage creates an immediate demand for replacement Traditional Tiles to repair the damage to roofs in order to make them weather tight. Unfortunately, Bermuda's quarrying capacity is limited and quarries cannot meet this immediate demand for Traditional Tiles, resulting in long delays to roof repairs. Also, the opening of new quarry sites is restricted due to a growing desire to protect environmentally sensitive land.

Currently there are a number of solutions for replacing the locally quarried Traditional Tiles with a manufactured roofing product. Some of these solutions attempt to provide a suitable substitute roofing tile product, but these solutions fail to meet the needs of the industry because they do not match the physical characteristics of Traditional Tile. Imported aerated autoclaved concrete (AAC) slate products of similar size are half the weight of Traditional Tile requiring them to be mechanically fastened to the wood framing with clips in order to attain sufficient resistance to wind uplift forces. Imported AAC roofing tile does not use any locally available recycled materials and exhibits thermal and moisture absorption characteristics that results in recurring cracks in the finished roof. Tradesmen laying AAC roofing tile must adjust mortar mix and laying down techniques to account for the increase rate of water absorption from AAC roofing tile resulting in a noticeable deviation from traditional practices of laying quarried limestone roofing tile. Other solutions attempt to manufacture a roofing tile product using traditional wet-mix flowable concrete but this solution is similarly unable to meet the needs of the industry because the flowable concrete mix slurry must be placed into individual molds and cured for up to seven days before de-molding. Also, this finished concrete product is denser and requires more effort to cut and shape individual pieces. The characteristics of a wet-mix concrete molded roofing tile do not closely resemble that of the Traditional Tile resulting in rejection by local tradesmen as an inferior roofing tile that deviates too far from the traditional quarried limestone roofing tile product.

It would be desirable to have a locally manufactured roofing tile product that is made from up to 70% recycled materials included post-consumer glass (recycled glass, hereinafter referred to as “RG”) and that can be stockpiled in large quantities without deteriorating and stacked to reduce inventoried storage space. This would ensure sufficient quantities are available during peak demand periods such as post hurricane repairs to existing Traditional Tile roofs. Furthermore, it would also be desirable to have a manufactured roofing tile that is the exact same size and weight as the Traditional Tile product but is stronger and more durable to reduce breakage during transportation and handling. Still further, it would be desirable to have a roofing tile that exhibits characteristics similar to Traditional Tile that tradesmen find desirable when handling, cutting and laying the tile on timber framed roofs. Still further, it would be desirable to have a roofing tile that has low thermal expansion and low moisture absorption characteristics in order to reduce cracking and the associated regular repairs to cracks in stone tile roofs. Still further, it would be desirable to have a roofing tile that enables it to be mechanically fastened to the underlying timber framing in order to improve resistance to uplift and roof damage during severe high winds. Still further it would be desirable protect Bermuda's natural environment by reducing Bermuda's dependence on quarrying natural stone for use as a roofing tile. Therefore, there currently exists a need in the industry for a Bermuda manufactured roofing tile that is a better substitute to match Traditional Tiles and uses up to 70% locally available recycled materials in its composition.

### SUMMARY OF THE INVENTION

The present invention is directed to a roof tile with an improved composition and a method of making the same, wherein the composition and method results in a roofing product of specific size and weight using RG and other aggregate.

In its most complete version the optimum mix design to achieve a desirable manufactured roofing tile product is formulated from the following components proportioned by weight; 15-60% RG (also known as cullet) with washed particle sizes equally distributed from fine dust to ¼ inch (0.64 cm) sieve size, 20-25% fine aggregate sand, 12-20% perlite with cumulative particle size of 40-85% by weight passing thorough #16 mesh-sieve, 10-20% Portland cement Type 2, 2-5% pumice and 1% clean water.

These components are connected as follows; the dry components, being all of the listed components above save for the water, are mechanically blended together thoroughly and fresh water is slowly added until a homogenous damp mix is achieved that exhibits an optimum moisture content with no excess free water. Optimal moisture content being achieved when the majority of the damp mix stays clumped together in a ball when compressed in the hand. No additional free water should be added after this stage. The damp homogenous mix is loosely transferred to molds sized and proportioned to achieve the desired final roofing tile dimensions of 18″×12″×1″ (45.7 cm×30.4 cm×2.5 cm) after compactive force is applied. Hydraulic rams are lowered into the loose homogenous damp mix within the mold frame and compactive force is applied for a defined period of time sufficient to achieve the desired finished roofing tile density and strength characteristics. The compactive force is then removed and the ram raised allowing the mold frame to lifted clear of the molded roofing tile and base plate. The molded tile and temporary base plate is carefully moved away from the work area and allowed to cure until the tile has reached sufficient strength to be manhandled and removed from its base plate without damaging the tile. The roofing tile product in then stored on edge for a further period of time until it has achieved full strength at which time it is bundled and wrapped with other roofing tiles and pelletized ready for transporting to construction sites or stored for long term emergency use.

It is an object of this invention to provide a method of manufacturing a superior roofing tile using local labor and equipment reducing the delays and costs of importing roofing tiles. Further still it is an object of this invention to provide a way to manufacture roofing tile that is stronger, more durable and more economical than other locally available solutions. Still further it is an object of this invention to utilize stockpiles of locally available RG in the mix design promoting a “green” environmentally positive product from waste material.

The invention will now be described more fully hereinafter with reference to the accompanying drawings, which are intended to be read in conjunction with both this summary, the detailed description and any preferred and/or particular embodiments and variations specifically discussed or otherwise disclosed. This invention may, however, be embodied in many different forms and should not be construed as limited to the embodiments set forth herein; rather, these embodiments are provided by way of illustration only and so that this disclosure will be thorough, complete and fully conveys the full scope of the invention to those skilled in the art.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a schematic depicting a sequence of operation for making a roofing tile in accordance with the present application;

FIG. 2 is a flowchart depicting the composition of the roofing tile of FIG. 1; and

FIG. 3 is a flowchart of the method of making the roofing tile of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional socks and tight systems. Specifically, the present invention provides for the use of biodegradable materials to decrease the impact of the clothing on the environment. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

As discussed, the invention has many different features, variations and multiple different embodiments. The invention has been described in this application at times in terms of specific embodiments for illustrative purposes and without the intent to limit or suggest that the invention conceived is only one particular embodiment. It is to be understood that the invention is not limited to any single specific embodiments or enumerated variations. Many modifications, variations and other embodiments of the invention will come to mind of those skilled in the art to which this invention pertains, including but not limited to the size of roofing tile produced, and which are intended to be and are covered by this disclosure. It is indeed intended that the scope of the invention should be determined by proper interpretation and construction of the claims, including equivalents, as understood by those of skill in the art relying upon the complete disclosure at the time of filing.

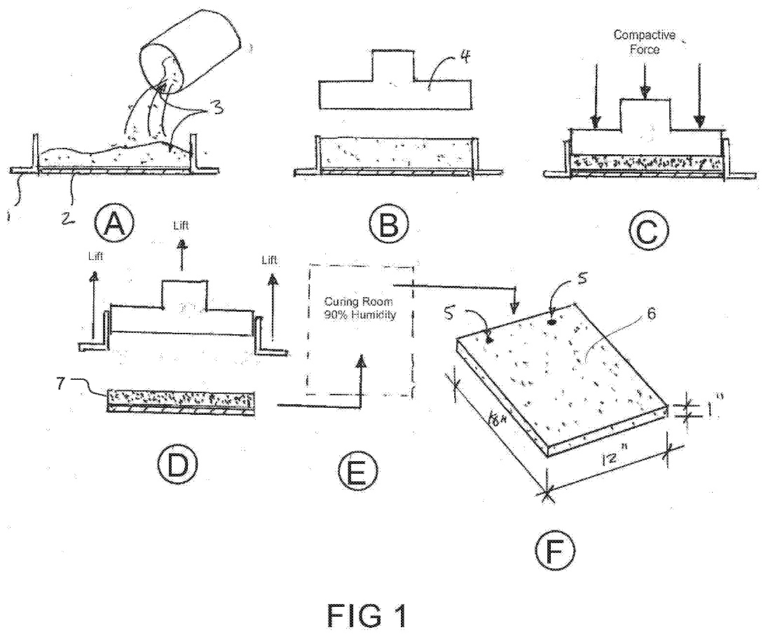

Referring now to the drawings, in FIG. 1, a simplified schematic depicts the creation of a roofing tile 6 via steps A-F. As shown, after the damp mixture is created, the damp mixture 3, is placed into a mold frame 1, the mold frame being of a desirable size and having a removable base plate 2, as shown in step A. The damp mixture is then leveled to the top of the mold frame 1, as shown in step B. Next, a hydraulic ram 4 is lowered onto the damp mixture and is configured to apply a compactive and/or vibratory force to the damp mixture, thereby creating a compacted tile 7 within the frame, as shown with step C. The force is removed and the mold frame and base plate are separated, as shown with step D. The resulting compacted tile is then left in a curing room to reach a desired strength, thereby ultimately resulting in the roofing tile 6, as shown with steps E and F.

As shown, in the preferred embodiment, the resulting roofing tile has dimensions of 18″ by 12″ by 1″, however it is contemplated that the size can vary based on user needs.

Further, as shown in FIG. 1, the tile 101 can include anchorage holes 5 for securing the tile to a roofing structure during construction.

It should be appreciated that one of the unique features believed characteristic of the present invention is the composition of the roofing tile. The composition of the roofing tile provides for a durable tile that can replace conventional tiles and further utilizes recycled materials.

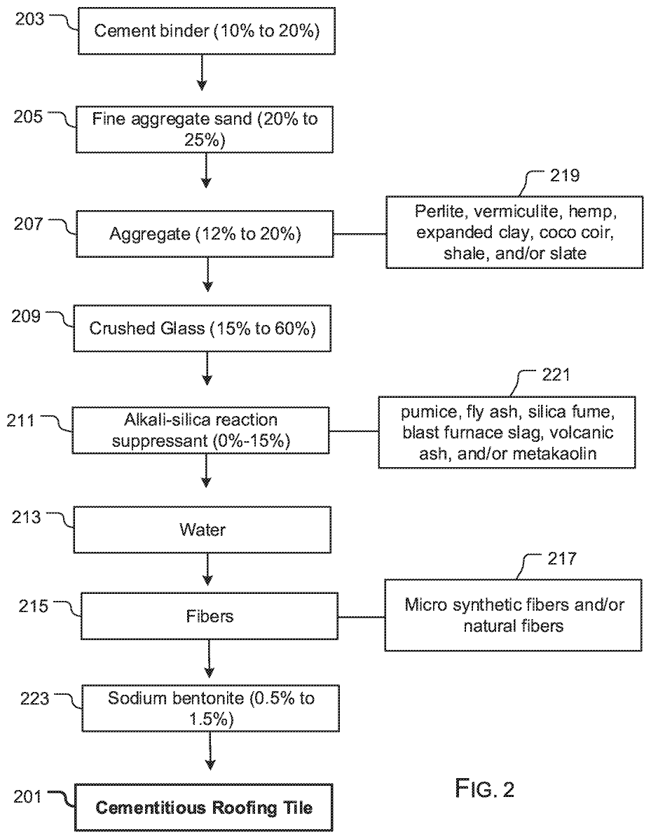

In FIG. 2, a flowchart depicts a summary of the composition of a roofing tile 201 in accordance with the present application. As shown, in the preferred embodiment the composition for a cementitious roofing tile 201 comprises: a cement binder 203 making up 10% to 20% of a total composition weight; a fine aggregate sand 205 making up 20% to 25% of the total composition weight; an aggregate 207 making up 12% to 20% of the total composition weight; a crushed glass 209 making up 15% to 60% of the total composition weight; an alkali-silica reaction (ASR) suppressant 211; and water 213.

In some embodiments, it is further contemplated that additional fibers 215 can be included for improved strength and resistance to cracking of the roofing tile 201. The fibers 215 could optionally be micro synthetic fibers or natural fibers 217.

In various embodiments, it is contemplated that the aggregate 207 is selected from one of perlite, vermiculite, hemp, expanded clay, coco coir, shale, and/or slate 219. It should however be appreciated that there could be other aggregates known or discovered in the future that could operationally function as well.

Similarly, it is contemplated that in various embodiments, the alkali silica reaction suppressant is one or more of pumice, fly ash, silica fume, blast furnace slag, volcanic ash, and/or metakaolin 221. However, alternatives could replace this non-exclusive list

In the preferred embodiment the average particle size of the fine aggregate sand, as well as the aggregate, varies from 1 micron to a maximum size of 2 mm. The average particle size of the crushed glass preferably ranges from size 1 micron to a maximum of 5 mm.

In yet some embodiments, the fine aggregate may have an average particle size of 1 mm or less.

In various embodiments, the alkali-silica reaction (ASR) suppressant makes up 0% to 15% of the total composition weight. In yet some compositions, an additional dry ingredient, namely sodium bentonite 223 is included and makes up 0.5% to 1.5% of the total composition weight.

Preferably, the composition has a dry unit weight in the range of 1050-1350 kg/m³ after setting.

A cementitious roof tile made from the composition should have a minimum 28 day compressive strength in the range of 2-5 MPa after setting. It should preferably measure 18″×12″×1″ (45.7 cm×30.4 cm×2.5 cm). It may have one or more predetermined slotted anchorage holes formed at one end of the tile to accommodate screw fixing to underlying timber roof framing during roof installation.

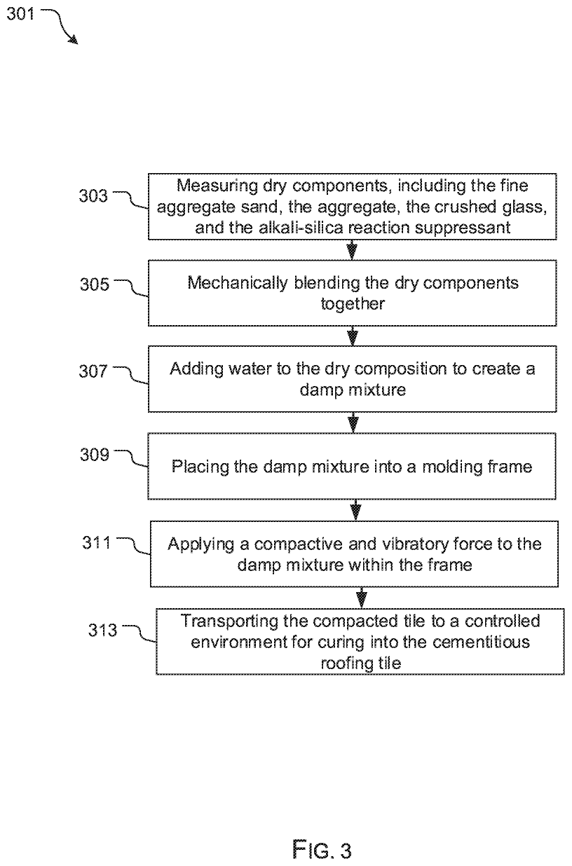

In FIG. 3, a flowchart 301 depicts a method of manufacturing of the roofing tile of the present invention. The method includes first measuring a predetermined amount by weight percentage of dry components, the dry components including the fine aggregate sand, the aggregate, the crushed glass, and an alkali-silica reaction (ASR) suppressant, as shown with box 303. Next, the dry components are mechanically blended together to form a homogenous dry composition mixture, as shown with box 305. It should be appreciated that the mechanical blending can be achieved via any known method in the art.

Next, a volume of water is added to the homogeneous dry composition mixture, thereby forming a damp mixture, as shown with box 307. The damp mixture is then placed within the predetermined sized molding frame, the molding frame having a removable base plate as discussed in connection with FIG. 1, as shown with box 309. Compactive and/or vibratory force is applied to the damp mixture within the molding frame to achieve a desired finished shape and a compacted tile within the frame, as shown with box 311. The compacted tile is then removed from the molding frame by disengaging the base plate from the remainder of the frame and transported to a controlled environment for curing until a desired strength associated with the compacted tile has been established for safe handling and transportation to construction sites, as shown with box 313. In the preferred embodiment, the aggregate is selected from one of perlite, vermiculite, hemp, expanded clay, coco coir, shale and slate.

It should be appreciated that the mix design and method for manufacturing a roofing tile of the present invention utilizes up to 70% locally available materials and is a superior replacement for Traditional Tiles. This manufactured roofing tile is made up of the following components, a cement binder, RG, a lightweight aggregate, a fine aggregate, an alkali-silica reaction (ASR) suppressant and water. These components are connected as follows; the optimum proportions of components are measured by weight and mechanically blended together as a dry cementitious composition. A small quantity of clean water is added to the dry mix composition in an amount only necessary to achieve optimum moisture content for compaction and to effect hydraulic setting of the cementitious composition, without adding any additional free water to the mix. A removable base plate sits at the bottom of the molding frame ready to receive a charge of damp mix material. The damp mix is loaded into the mold frame which is sized and shaped to achieve the desired finished shape of the roofing tile product after compaction. A hydraulic ram press applies compactive force within the mold confines for a predetermined length of time. The compactive force is then removed and the mold frame is lifted free from the compacted tile product. The tile product and base plate is removed from the work area and allowed to cure in an environment with 90% relative humidity until it reaches sufficient strength to be safely handled without breakage. The roof tiles are then removed from the reusable base plate and stored on edge until full strength is achieved. The finished roofing tile is then bundled in groups and stacked on edge on wood pallets ready for transporting to the construction site.

The mix design and method may also have one or more of the following variations: other light weight aggregate may be substituted for perlite, specifically vermiculite, hemp, expanded clay, coco coir, shale, and slate; industrial waste by-products, such as fly ash, expanded slag cinder, and bed ash. Proportions of component aggregates may be varied provided the finished dry weight of the roofing tile falls between a minimum value of 8 lbs (3.63 kg) and a maximum value of 12 lbs (5.45 kg) and exhibits the same desirable strength, durability, handling and working characteristics of the optimum mix ratios described herein. A variety of commonly known pozzolans may be used as alkali-silica reaction suppressant substitutes for fly ash, namely pumice, calcined clay, calcined shale, metakaolin, slag and silica fume. A small quantity of sodium bentonite may be added to improve molding characteristics and reduce wastage during molding, de-molding and handling. Micro synthetic or natural fibers may be added to the mix design to improve strength and resistance to cracking. The roofing tile product may be molded with one or two slotted anchorage holes of 3/16″ (0.38 cm) diameter to facilitate mechanically fixing the slate to the wood framing with industry standard wood screws and large diameter plastic washers without having to drill through the tile. The roofing tile may be molded with one end at a predetermined angle to accommodate the installation or roof hips and valleys eliminating the need to saw cut these angular tiles on site.

The disclosed manufactured roofing tile is unique when compared with other known roofing tile products and solutions because it: (1) uses locally available recycled components including RG in the design mix, reducing the need for costly imported materials (2) produces a superior roofing tile product that is stronger and more durable than Traditional Tile resulting in less wastage during storage, transportation and handling (3) can be palletized and stacked higher for long term emergency inventories without any deterioration in quality, (4) can be manufactured in climate controlled indoor facilities 24 hrs a day, 7 days a week unlike Traditional Tile which is weather dependent, (5) can be molded in various angular shapes to accommodate the construction of roof hips and valley features without the need to saw cut on site.

Among other things, it is an object of the present invention to provide a method and mix design for making a cementitious roofing product of specific size and weight using post-consumer glass and other aggregate that produces a roofing tile product that does not suffer from any of the problems or deficiencies associated with previous solutions.

The disclosed manufactured roofing tile is unique in that it is structurally different from other known roofing tiles or solutions. More specifically, the roofing tile is unique due to the presence of: (1) RG and other components in the mix design in a proportion and grading that achieves the most desirable characteristics of a roofing tile substitute for Traditional Tile; (2) can be molded with only the optimum level of moisture for a damp mix design to achieve compaction allowing for immediate release from the mold; and (3) can be molded with pre-formed slotted screw holes to allow the option of securing the tile to the wood framing with wood screws for additional uplift resistance during severe windstorms (4) is strong and durable enabling it to be palletized and stacked to reduce storage space (5) is of similar weight and size of Traditional Tile enabling a true like-for-like substitute for Traditional Tile for a ballast type roof with no deviation from accepted local practice in building and finishing a stone tile ballast roof covering.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A composition for a cementitious roofing tile, the composition comprising:
a cement binder making up 10% to 20% of a total composition weight;
a fine aggregate sand making up 20% to 25% of the total composition weight;
an aggregate making up 12% to 20% of the total composition weight;
a crushed glass making up 15% to 60% of the total composition weight;
an alkali-silica reaction (ASR) suppressant;
and a predetermined volume of water;
wherein the aggregate is selected from one of perlite, vermiculite, hemp, expanded clay, coco coir, shale and slate; and
wherein the fine aggregate sand has an average particle size from a minimum of 1 micron to a maximum size of 2 mm; and
wherein the crushed glass has an average particle size that ranges from 1 micron to a maximum of 5 mm.

2. The composition of claim 1, wherein the average particle size of the fine aggregate sand is less than 1 mm.

3. The composition of claim 1, wherein the alkali-silica reaction (ASR) suppressant is at least one selected from the group consisting of natural pumice, fly ash, silica fume, blast furnace slag, volcanic ash, and metakaolin.

4. The composition of claim 1, wherein the alkali-silica reaction (ASR) suppressant makes up 0% to 15% of the total composition weight.

5. The composition of claim 1, further comprising:
an additive composed of sodium bentonite making up 0.5% to 1.5% of the total composition weight.

6. The composition of claim 1, wherein the composition has a dry unit weight in the range of 1050-1350 kg/m³ after setting.

7. The composition of claim 1, wherein the cementitious roofing tile has a minimum 28 day compressive strength in the range of 2-5 MPa after setting.

8. The composition of claim 1, wherein the cementitious roofing tile further comprises:
a body measuring 18″×12″×1″ and having one or more predetermined slotted anchorage holes formed at one end of the tile to accommodate screw fixing to underlying timber roof framing during roof installation.

9. The composition of claim 1, further comprising:
fibers configured to increase composition strength and resistance to cracking.

10. The composition of claim 9, wherein the fibers are one of micro synthetic fibers and natural fibers.

11. The composition of claim 1 wherein the cement binder is hydraulic.

12. The composition of claim 1, wherein the cement binder is non-hydraulic.

10. A method for manufacturing a cementitious roofing tile, the method comprising:
measuring a predetermined amount by weight percentage of dry components, the dry components including, a fine aggregate sand, an aggregate, a crushed glass and an alkali-silica reaction (ASR) suppressant;
mechanically blending the dry components to form a homogenous dry composition mixture;
adding a predetermined volume of water to the homogeneous dry composition mixture;
forming a damp mixture;
placing the damp mixture in a predetermined sized molding frame, the molding frame having a removable base plate;
applying a compactive and vibratory force to the damp mixture within the molding frame to achieve a desired finished shape of a compacted tile;
removing the compacted tile from the molding frame; and
transporting the compacted tile to a controlled environment for curing until a desired strength associated with the compacted tile has been established for safe handling and transportation to construction sites;
wherein the aggregate is selected from one of perlite, vermiculite, hemp, expanded clay, coco coir, shale and slate.
